(19) United States
(12) Patent Application Publication
(10) Pub. No.: US 2010/0035085 A1
(43) Pub. Date: Feb. 11, 2010

(54) PERPENDICULAR MAGNETIC RECORDING MEDIUM WITH IMPROVED MAGNETIC ANISOTROPY FIELD

(75) Inventors: Hong-Sik Jung, Pleasanton, CA (US); Gerardo Bertero, Redwood City, CA (US); Emur Velu, Fremont, CA (US); Michael Cheng-Chi Kuo, Fremont, CA (US); B. Ramamurthy Acharya, Fremont, CA (US); Sudhir Malhotra, Fremont, CA (US)

Correspondence Address: WESTERN DIGITAL TECHNOLOGIES, INC.;ATTN: LESLEY NING, 20511 LAKE FOREST DR., E-118G, LAKE FOREST, CA, 92630, US

(73) Assignee: WD Media, Inc., Lake Forest, CA (US)

(21) Appl. No.: 12/525,539

(22) PCT Filed: Jan. 29, 2008
(86) PCT No.: PCT/US08/01140

§ 371 Date: Oct. 16, 2009

Related U.S. Application Data
(60) Provisional application No. 60/899,232, filed on Feb. 3, 2007.

(51) Int. Cl. G11B 5/706; B05D 5/12

(52) U.S. Cl. 428/800; 427/131

(57) ABSTRACT

A perpendicular magnetic recording medium comprising a substrate, a soft underlayer, a seed layer, a non-magnetic FCC NiW alloy underlayer, a non-magnetic HCP underlayer, and a magnetic layer. We have discovered that the combination of a seed layer comprising Ta and a NiW alloy underlayer uniquely improves media recording performance and thermal stability by achieving excellent coercivity of the thin bottom magnetic recording layer and narrow C axis orientation distribution.

### BACKGROUND OF THE INVENTION

This invention pertains to perpendicular magnetic recording media and methods for making perpendicular magnetic recording media.

FIG. 1 illustrates a prior art magnetic recording medium 10 used for perpendicular recording. Medium 10 comprises a substrate 11, an adhesion layer 12, a soft underlayer (“SUL”) structure 13, a Ta seed layer 14, a hexagonal close packed (“HCP”) RuCr₃₀ alloy layer 15, a HCP Ru layer 17, a bottom magnetic HCP CoCr₁₇Pt₁₈(SiO₂)₂ alloy layer 18, a capping magnetic HCP CoCr₁₆Pt₁₈(TiO₂)_{1.5} alloy layer 19, and a carbon protective overcoat 20. The <0001> axis (the C axis) of the HCP crystals of layers 18 and 19 preferentially orient vertically. Layers 14, 15 and 17 are provided to promote vertical orientation of the C axis and to enhance grain isolation in layers 18 and 19 when layers 18 and 19 are deposited which result in enhancing the coercivity Hc of magnetic layers 18 and 19.

Layers 18 and 19 store magnetically recorded data when the medium is in use. The Hc of layer 18 is greater than that of layer 19. During reactive sputtering, amorphous oxide grain boundaries in layer 18 form to decouple the magnetic grains of layer 18 so that individual grains of layer 18 can magnetically switch independently, thereby reducing noise exhibited by layer 18. The oxide content of layer 18 is controlled by both oxide content in a given target and degree of reactive sputtering. Unfortunately, formation of amorphous oxide grain boundaries can degrade the vertical orientation of the magnetization and cause broad switching field distribution in layer 18, as discussed in H. S. Jung et al., “Effect of Oxygen Incorporation on Microstructure and Media Performance in CoCrPt—SiO₂ Perpendicular Recording Media”, IEEE Transactions on Magnetics, Vol. 43, No. 2, pp. 615-620, February 2007. Layer 19 (which has either no or reduced oxide content and more intergranular exchange interaction than layer 18) is used to tailor the magnetic characteristics of layer 18 and improve the vertical orientation of magnetization in the dual magnetic layers 18, 19.

SUL structure 13 consists of soft magnetic layers 13a and 13c separated by a thin Ru layer 13b. Layers 13a and 13c are antiferromagnetically coupled to each other due to Ru layer 13b. SUL structure 13 provides a magnetic return path from the write pole to the return pole of a read-write head (not shown).

As mentioned above, layers 15 and 17 consist of RuCr₃₀ and Ru, respectively. In order to achieve narrow crystallographic C axis orientation distribution and excellent crystallinity, a thicker RuCr₃₀ underlayer 15 is needed. Unfortunately, Ru is expensive and in short supply. Accordingly, it would be desirable to reduce the number of Ru-containing layers in medium 10 while still achieving good vertical orientation of layers 18 and 19 and a high Hc.

Other vertical magnetic recording media are discussed in U.S. Patent Application 2004/0247945, U.S. Pat. No. 7,067,206, U.S. Patent Application 2006/0093867, U.S. Pat. No. 6,902,835, U.S. Patent Application 2003/0170500, U.S. Patent Application 2004/0023074, and U.S. Patent Application 2006/0275629.

### SUMMARY

A magnetic recording medium comprises first, second and third underlayers and a magnetic recording layer. The magnetic recording layer is a HCP material typically comprising one or more magnetic Co alloy layers. The underlayers promote vertical orientation of the C axis of the magnetic layers and enhance grain isolation, resulting in an increase in the coercivity of the magnetic layers. The first underlayer is a seed layer that typically comprises amorphous Ta or a Ta alloy and is non-magnetic.

The second underlayer is non-magnetic and typically comprises a NiW alloy and typically has a FCC crystal structure. In one embodiment, the second underlayer comprises NiWₓ, where x is between 6 and 15. The remainder of the alloy comprises Ni. In another embodiment, the remainder of the alloy contains other additives, but in other embodiments the remainder of the alloy is about 100% Ni.

The third underlayer is typically a non-magnetic HCP material, and can comprise Ru (including a Ru-based alloy) or a Co-based alloy that can comprise one or more of Cr, Ta, W, Mo, Nb, Ti, Hf, Y, V, Sr, and Ni. We have discovered that by using these materials we can achieve good crystal growth (e.g. with vertical orientation of the C axis of the magnetic layer) and high magnetic coercivity while using less Ru than medium 10. We have also discovered that we can achieve reduced transition noise and improved thermal stability.

In one embodiment, the medium comprises two magnetic layers formed above the underlayers.

In one embodiment, the medium comprises a substrate and a SUL formed underneath the underlayers. It is desirable to minimize the thickness of the layers between the SUL and the magnetic layers. Of importance, by using a seed layer comprising Ta and a second underlayer comprising a NiW alloy, we are able to achieve this objective.

In one embodiment, the SUL comprises first and second soft magnetic layers separated by a thin Ru layer. The first and second soft magnetic layers are antiferromagnetically coupled to one another. However, in another embodiment, the SUL comprises only a single layer.

As mentioned above, we can achieve a high Hc owing to the unique combination of underlayers comprising Ta and NiW, for the case of a single or a bottom magnetic layer, we can achieve a high Hc of about 7 kOe even when the bottom magnetic recording layer is thin, e.g. 7 nm, while simultaneously achieving excellent crystallographic C axis orientation. A benefit of the high Hc in the thin bottom magnetic recording layer is the reduction of transition noise and improved thermal stability in dual magnetic recording layers. We have been able to achieve a medium signal-to-noise ratio SNRₘₑ improvement of 0.6 to 1.3 dB compared to conventional underlayer structures.

### BRIEF DESCRIPTION OF THE DRAWINGS

FIG. 1 illustrates in cross section a magnetic recording medium constructed in accordance with the prior art.

FIG. 2 illustrates in cross section a magnetic recording medium constructed in accordance with a first embodiment of the invention.

FIG. 3 illustrates in cross section a magnetic recording medium constructed in accordance with a second embodiment of the invention.

FIG. 4 illustrates the relationship between the thickness of various non-magnetic underlayers and the coercivity Hc of a bottom magnetic recording layer.

FIGS. 5A and 5B illustrate the relationship between the thickness of various non-magnetic underlayers and the crystal orientation of subsequently deposited Ru and Co alloy layers.

FIG. 6 illustrates the relationship between the thickness of various non-magnetic underlayers and the coercivity Hc of dual magnetic recording layers.

FIG. 7 illustrates the relationship between the thickness of various non-magnetic underlayers and the saturation field Hs of dual magnetic recording layers.

FIG. 8 illustrates the relationship between the thickness of various non-magnetic underlayers and the nucleation field Hn of the dual magnetic recording layers.

FIG. 9 illustrates the relationship between the thickness of various non-magnetic underlayers and the magnetic write width (“MWW”) of dual magnetic recording layers.

FIG. 10 illustrates the relationship between the thickness of various non-magnetic underlayers and the medium signal-to-noise ratio SNRₘₑ of dual magnetic recording layers.

FIG. 11 illustrates the relationship between the thickness of various non-magnetic underlayers and the DC erase signal-to-noise ratio SNR_{DC} of dual magnetic recording layers.

FIG. 12 illustrates the relationship between the thickness of various non-magnetic underlayers and the reverse overwrite performance OW2 of dual magnetic recording layers.

FIG. 13 illustrates the relationship between the thickness of a non-magnetic NiW₁₀ layer and the temperature coefficient of remanent coercivity dHcr/dT of dual magnetic recording layers.

FIGS. 14A and 14B illustrate the effect of a Ta seed layer and the thickness of a non-magnetic NiW₁₀ layer on the crystallographic C axis orientation of a subsequently deposited Ru and Co alloy layer.

FIG. 15A illustrates the relationship between the thickness of a NiW₁₀ alloy layer and the SNRₘₑ of a magnetic recording medium in the presence and absence of a Ta seed layer.

FIG. 15B illustrates the relationship between the thickness of a NiTi₁₀ alloy layer and the SNRₘₑ of a magnetic recording medium in the presence and absence of a Ta seed layer.

FIG. 16 illustrates in cross section a magnetic disk drive including a magnetic disk in accordance with our invention.

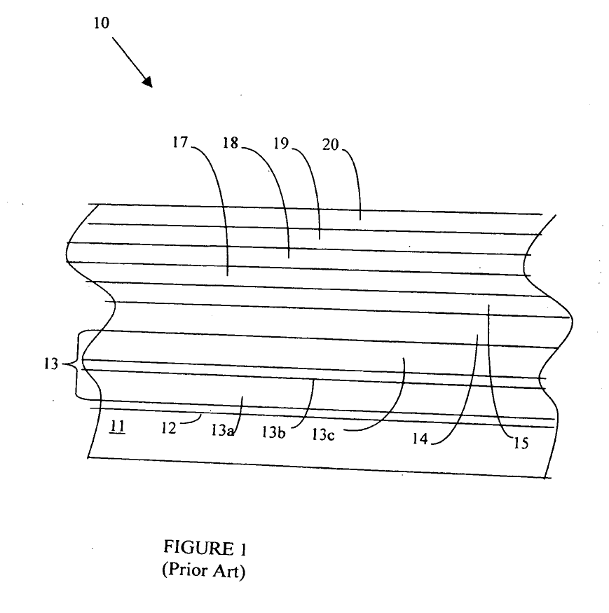

### DETAILED DESCRIPTION

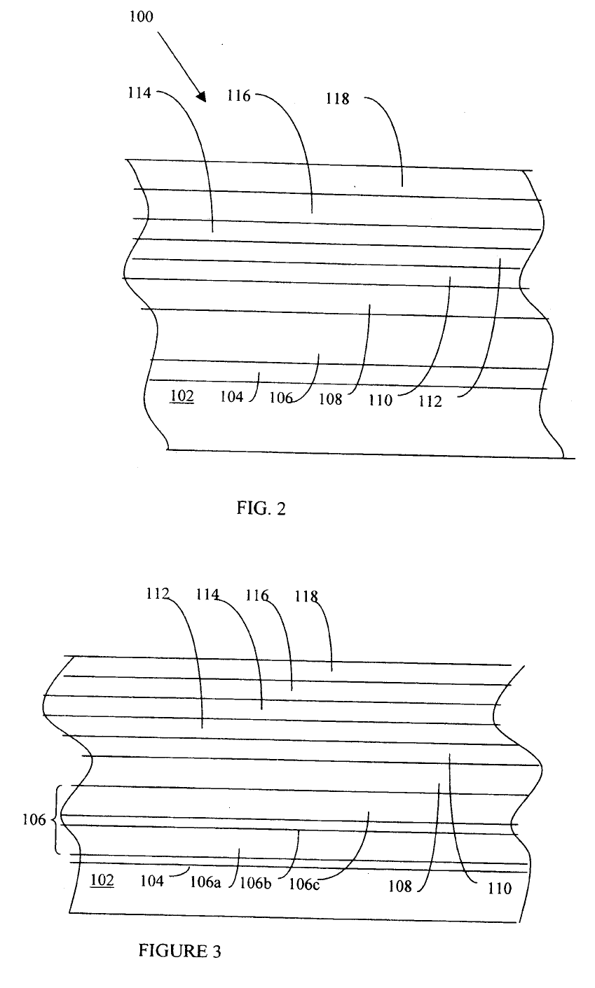

Referring to FIG. 2, a magnetic recording medium 100 comprises a substrate 102, an adhesion layer 104, a SUL 106, a seed layer 108, a non-magnetic layer 110, a HCP non-magnetic layer 112, a bottom magnetic recording layer 114, a capping magnetic recording layer 116 and a protective carbon overcoat 118. A thin lubricant layer such as perfluoropolyether (not shown) can be applied to the top surface of overcoat 118. Although FIG. 2 only shows the various layers on one side of substrate 102, typically, these layers are formed on both sides of substrate 102.

Substrate 102 can be glass, glass ceramic, a NiP-plated aluminum alloy substrate (e.g. an AlMg substrate), or other appropriate material. Substrate 102 can be either textured or non-textured.

Adhesion layer 104 can be Cr, CrTi, Ti, or other material. In one embodiment, layer 104 is 5 nm thick Ti, although other thicknesses can be used. Alternatively, adhesion layer 104 can be omitted.

SUL 106 can comprise Co-based magnetically soft materials, e.g. Co alloyed with one or more of Ta, Zr, Nb, Ni, Fe and B. Alternatively, SUL 106 can comprise a Co-based magnetically soft material containing an oxide and one or more of Ta, Zr, Nb, Ni, Fe and B. In another embodiment, SUL 106 can comprise first and second soft magnetic layers 106a, 106c separated by a thin Ru intermediate layer 106b (see FIG. 3). In one such embodiment, layer 106a is a 40 nm thick CoTa₅Zr₅ alloy, layer 106b is Ru between 6 and 9 angstroms thick (e.g. 8 angstroms), and layer 106c is 40 nm thick CoTa₅Zr₅. In the embodiment of FIG. 3, layers 106a and 106c are antiferromagnetically coupled due to the presence of Ru layer 106b.

Seed layer 108 is 3 nm thick amorphous Ta. However, in other embodiments, layer 108 can have other thicknesses, e.g. between 2 and 15 nm. Also, in other embodiments, layer 108 is a Ta alloy, e.g. comprising 90% to about 100% Ta.

Layer 110 is a non-magnetic FCC NiW alloy such as NiW₁₀, and can be between 1 and 15 nm thick, and preferably between 2 and 6 nm thick.

Layer 112 is 15 nm thick HCP Ru. However, in other embodiments, layer 112 can have other thicknesses. e.g. between 10 and 30 nm, and can be another HCP material such as an Ru based alloy, or a Co based alloy comprising one or more of Cr, Ta, W, Mo, Nb, Ti, Hf, Y, V, Sr or Ni.

Layer 114 can be CoCr₁₇Pt₁₈(SiO₂)₂ and 116 can be CoCr₁₆Pt₁₈(TiO₂)_{1.5}. Each of layers 114 and 116 is 7 nm thick, although in other embodiments, layers 114 and 116 have other compositions and thicknesses. Addition of oxide, SiO₂ in layer 114 and TiO₂ in layer 116, reduces intergranular exchange coupling between magnetic grains.

Carbon overcoat 118 can comprise a diamond-like hydrogenated carbon layer deposited by ion beam deposition covered by a flash layer of carbon. An example of an appropriate structure is discussed in U.S. Pat. No. 6,855,232, issued to Lairson et al., assigned to Komag, Inc. and incorporated herein by reference. Layer 118 can be 2.5 nm thick. However, other materials can be used in lieu of carbon, e.g. ZrO₂.

A magnetic disk in accordance with our invention can be manufactured by subsequently depositing layers 104, 106, 108, 110, 112, 114, 116 and 118 on substrate 102, e.g. by a vacuum deposition process such as sputtering, evaporation or other technique. As mentioned above, layer 118 can comprise two carbon-based sublayers, the first sublayer deposited by ion beam deposition and the second sublayer deposited by sputtering.

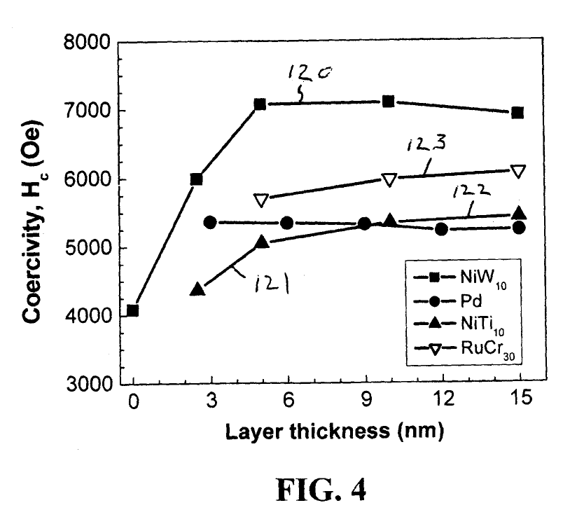

We have performed experiments that demonstrate the superiority of medium 100. FIG. 4 illustrates the relationship between the thickness of layer 110 (for the case in which layer 110 is nonmagnetic FCC NiW₁₀ and layer 108 is 3 nm thick amorphous Ta) and the Hc of bottom magnetic recording layer 114 (see curve 120) compared to media in which Pd, NiTi₁₀ and RuCr₃₀ were used in lieu of NiW₁₀ (see curves 121, 122 and 123). As can be seen, the disks comprising NiW₁₀ exhibited uniquely superior Hc, even when layer 108 was between 2.5 and 5 nm thick. The NiW₁₀ significantly increases Hc from 6 kOe for a thickness of 2.5 nm to about 7 kOe at a thickness of 5.0 nm even when the bottom recording layer 114 is only 7 nm thick.

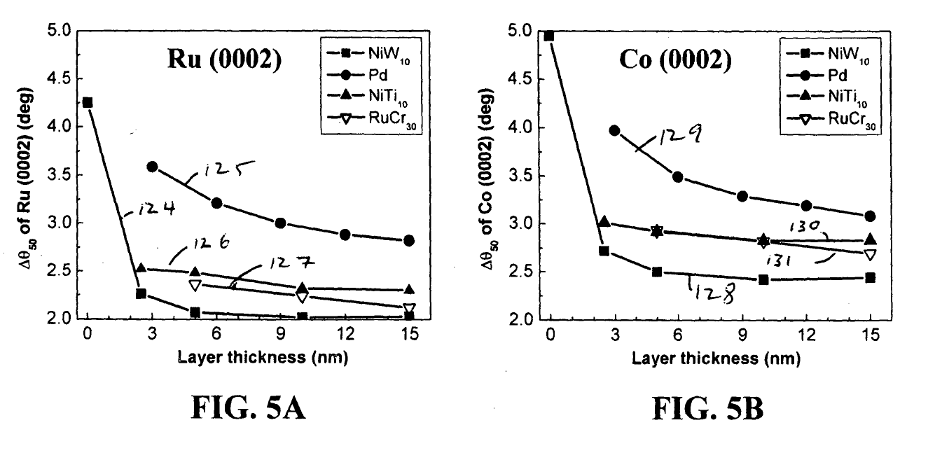

We have also demonstrated that the combination of a FCC nonmagnetic NiW alloy for layer 110 and amorphous Ta for layer 108 in accordance with our invention provides superior C axis crystal orientation in layers 112, 114 and 116. In particular, FIGS. 5A and 5B illustrate the relationship between a figure of merit Δθ₅₀ and the thickness of layer 110, as well as the corresponding relationships for Pd, NiTi₁₀ and RuCr₃₀ when layer 108 comprises Ta. Δθ₅₀ is a measure of variation in the orientation of the C axis as measured in degrees, determined by full width of the (0002) peak at half maximum in X-ray diffraction rocking curves. As can be seen, one can achieve a lower Δθ₅₀ of the (0002) planes for Ru and Co using NiW₁₀ (curves 124 and 128) than Pd (curves 125 and 129), NiTi₁₀ (curves 126 and 130) and RuCr₃₀ (curves 127 and 131). This means that advantageously, there is less variation in the alignment of the C axis in the Ru and Co magnetic layer when one uses a NiW₁₀ alloy in accordance with the present invention for layer 110.

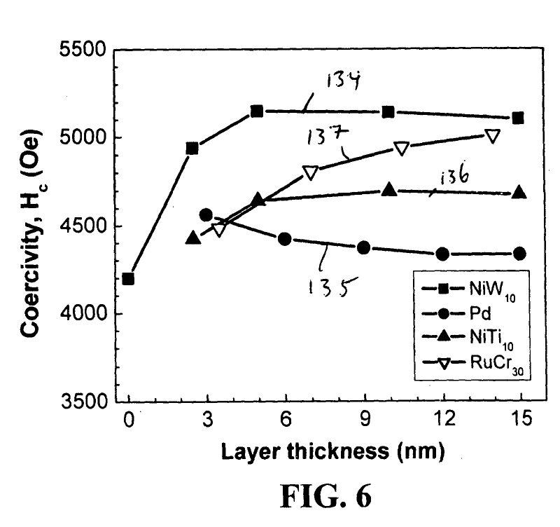

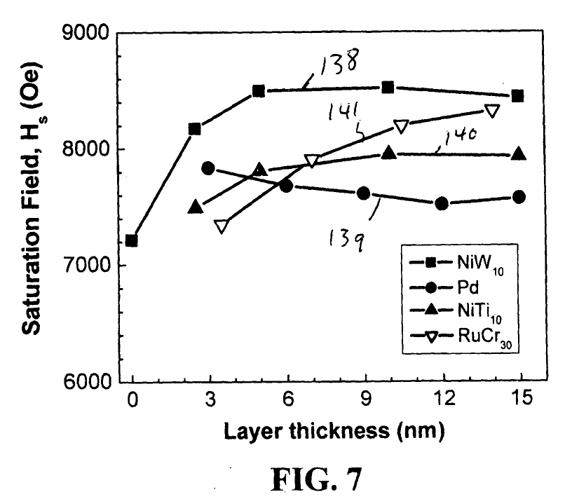

FIG. 6 illustrates the relationship between the thickness of layer 110 and Hc of dual magnetic recording layers 114, 116 (see curve 134) for the case in which layer 110 is NiW₁₀ and the corresponding relationship in which Pd, NiTi₁₀ and RuCr₃₀ were used in lieu of NiW₁₀ (see curves 135, 136 and 137). A 2.5 nm thick NiW₁₀ layer provides Hc of about 5 kOe, comparable to a 10 nm thick RuCr₃₀ layer (compare curves 134 and 137). (Again, 3 nm thick amorphous Ta was used as layer 108 for the data of FIG. 6 as well as FIGS. 7-13.)

FIG. 7 illustrates the relationship between the thickness of layer 110 and the saturation field Hs of dual magnetic recording layers 114, 116 as well as the corresponding relationships for Pd, NiTi₁₀ and RuCr₃₀. Once again, a 2.5 to 5 nm thick NiW₁₀ layer provides significantly increased Hs in the dual magnetic layers (curve 138) compared to Pd, NiTi₁₀ and RuCr₃₀ (curves 139, 140 and 141). Higher magnetic anisotropy constant Ku in bottom magnetic layer 114 providing higher Hc and Hs is important for reducing media transition noise but it limits media writeability. Values of Hs strongly affect media writeability. The role of top magnetic recording layer 116 helps minimize the side effects of well-isolated bottom magnetic recording layer 114 with high Ku by adjusting intergranular exchange interactions. The increase in Hc and Hs is caused by using NiW₁₀ but it provides more margins to control both composition and thickness in top magnetic recording layer 116 for further improvement of recording performance.

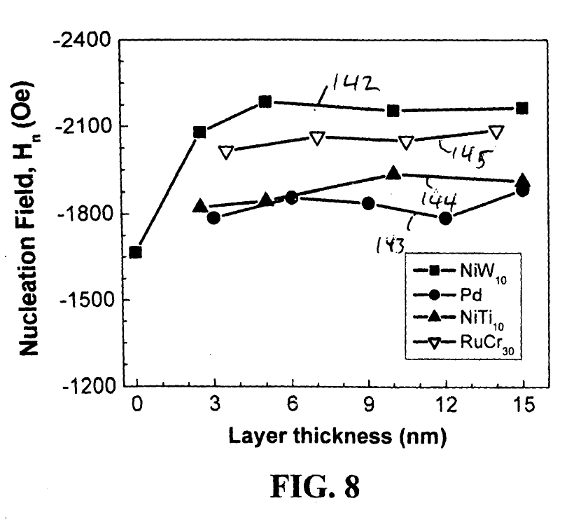

FIG. 8 illustrates the relationship between the thickness of layer 110 and the nucleation field Hn of dual magnetic recording layers 114, 116 (curve 142) as well as the corresponding relationships for Pd, NiTi₁₀ and RuCr₃₀ (curves 143, 144 and 145). Hn relates to adjacent track erasure (“ATE”) and strongly depends on Hc and intergranular exchange interactions. Higher values of Hn provide superior ATE, but they limit SNR due to the increase in transition noise if the increase in Hn is mostly caused by enhancing intergranular magnetic interactions. The medium in use typically should have a Hn value greater than −2.0 kOe. In FIG. 8, the values of Hn greater than −2.0 kOe are maintained at a thickness of the NiW₁₀ greater than 2.5 nm, mostly due to the significant increase in Hc.

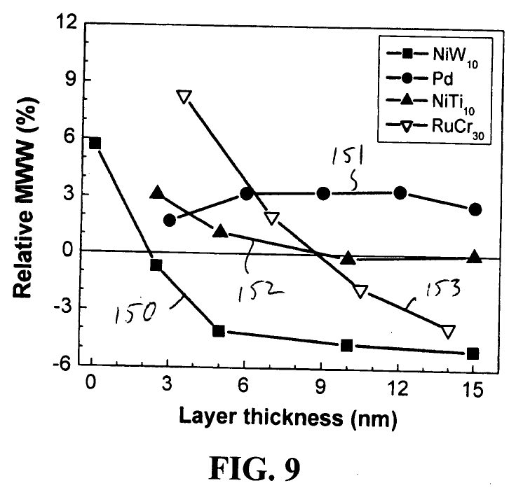

FIG. 9 illustrates the relationship between the thickness of layer 110 and the relative magnetic write width (“MWW”) of dual magnetic recording layers 114, 116 (curve 150) as well as the corresponding relationships for Pd, NiTi₁₀ and RuCr₃₀ (curves 151, 152 and 153). (The relative MWW is obtained by comparing the write width of a magnetic medium, using a given read-write head and a given standard magnetic disk.) Narrower MWW is highly desirable for supporting higher linear recording density. Reduced MWW is obtained even at a thickness of 2.5-5 nm thick NiW₁₀ layer due to the contribution of the high Hc in the bottom magnetic recording layer 114.

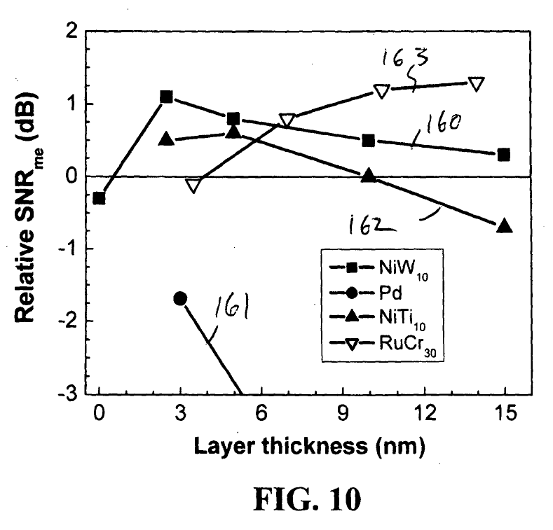

FIG. 10 illustrates the relationship between the thickness of layer 110 and the medium signal-to-noise ratio SNRₘₑ for the dual magnetic recording layers 114, 116 (curve 160) as well as the corresponding relationships for Pd, NiTi₁₀ and RuCr₃₀ (curves 161, 162 and 163). Superior SNRₘₑ is achieved even at 2.5 to 5 nm thick NiW₁₀ due to the contribution of narrow MWW caused by high Hc in the bottom magnetic recording layer 114.

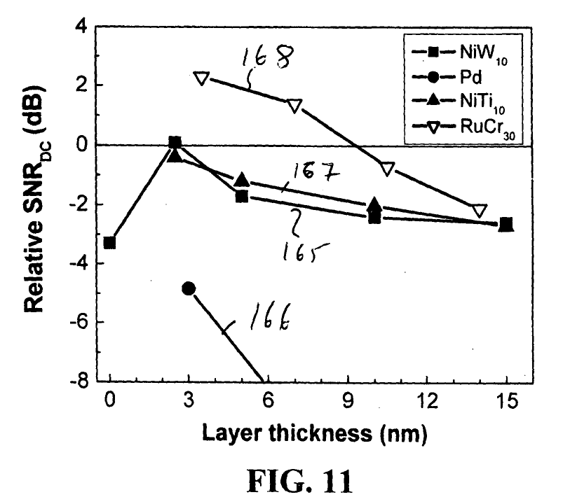

FIG. 11 illustrates the relationship between the thickness of layer 110 and the DC erase signal-to-noise ratio SNR_{DC} for dual magnetic recording layers 114, 116 (curve 165) as well as the corresponding relationships for Pd, NiTi₁₀ and RuCr₃₀ (curves 166, 167 and 168). SNR_{DC} is maintained at 2.5 nm thick NiW₁₀. This is a good indication because the medium has relatively high Hc and Hs compared with the other media indicated in the figures.

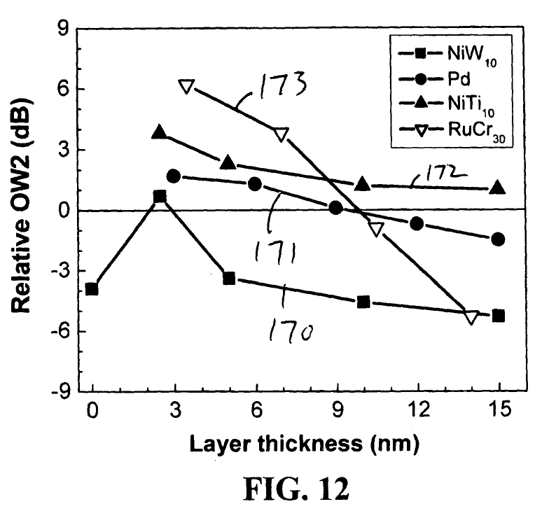

FIG. 12 illustrates the relationship between the thickness of layer 110 and the relative reverse overwrite for magnetic recording layers 114, 116 (curve 170) compared to Pd, NiTi₁₀ and RuCr₃₀ (curves 171, 172 and 173). Reverse overwrite (“OW2”) is measured by a procedure where the short wavelength pattern (2T) is overwritten by the long wavelength pattern (15T), where T is the minimum transition spacing in the drive operation. For the case of the drive used to generate FIG. 12, 1T equals 966 kFCI (966 thousand flux reversals per inch). As can be seen, a 2.5 nm thick NiW₁₀ provides less OW2 than Pd, NiTi₁₀ and RuCr₃₀ but the value is not worse when the high Hc and Hs are considered.

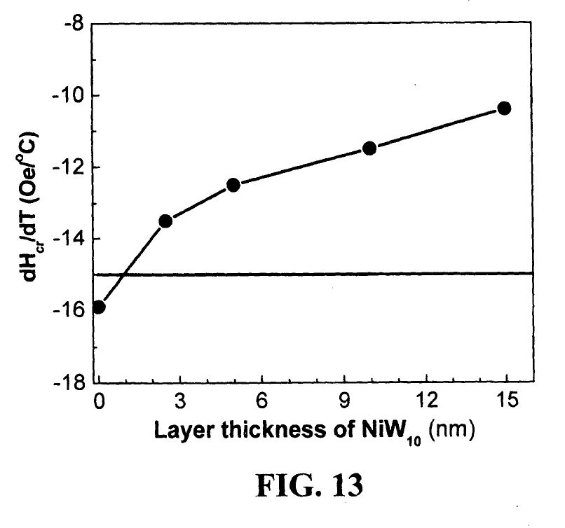

FIG. 13 illustrates the effect of the thickness of layer 110 and the temperature coefficient of remanent coercivity dHcr/dT. As is known in the art, it is desirable to have a stable remanent coercivity Hcr that does not vary with respect to temperature. Values of dHcr/dT less than −15 Oe/° C. are highly desirable for current magnetic recording applications. FIG. 13 shows that a thicker layer 110 significantly reduces temperature sensitivity of Hcr from −16 Oe/° C. at 0 nm to −14 Oe/° C. at 2.5 nm and −10 Oe/° C. at 15 nm.

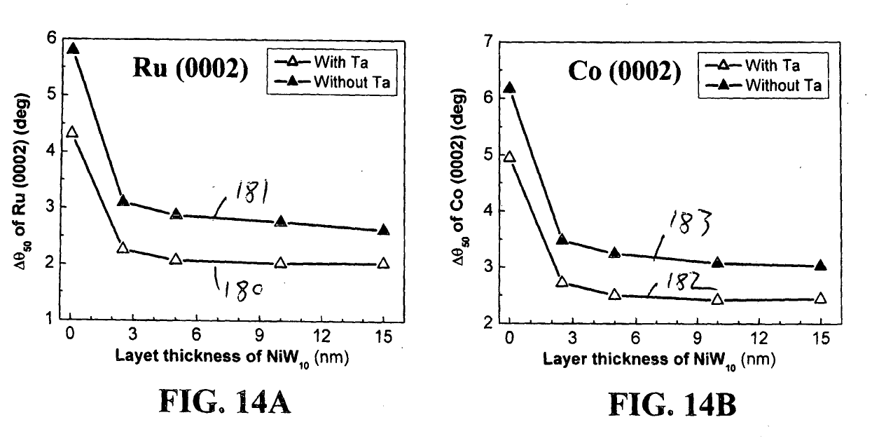

FIG. 14 illustrates the effect of the presence of Ta seed layer 108 and the crystal orientation of layers 112 (FIG. 14A) and layers 114, 116 (FIG. 14B). As can be seen, when Ta layer 108 is present (curves 180, 182), the Δθ₅₀ of the Ru and Co layers is lower, indicating more consistent vertical alignment, than when Ta layer 108 is absent (curves 181, 183). Use of Ta seed layer 108 achieves narrower C axis orientation of Ru and Co for further improvement of media performance.

Ta seed layer 108 also improves the Δθ₅₀ of layer 110. We have found that the Δθ₅₀ of NiW layer 110 is 2.3 when Ta seed layer 108 is present, and 3.0 when Ta seed layer 108 is absent.

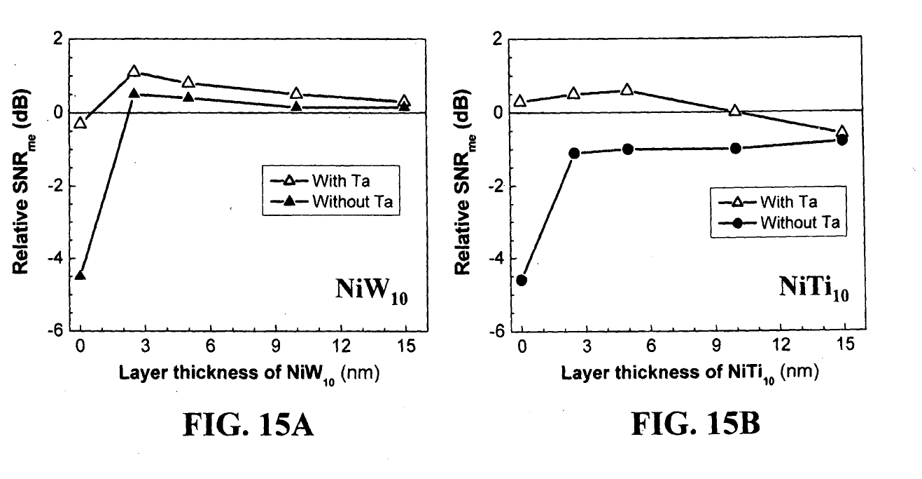

FIG. 15A illustrates the relationship between the thickness of layer 110 and the SNRₘₑ in the presence and absence (curves 190 and 191, respectively) of Ta seed layer 106. As can be seen, Ta improves the SNRₘₑ of the medium. FIG. 15B illustrates the relationship between the SNRₘₑ of a medium when NiTi₁₀ is used in lieu of NiW₁₀ both in the presence and absence (curves 192 and 193, respectively) of seed layer 106.

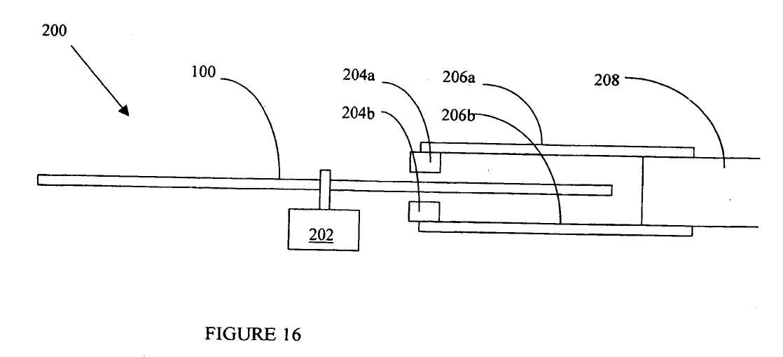

A magnetic medium in accordance with the invention is typically incorporated into a magnetic disk drive such as disk drive 200 (FIG. 16). Drive 200 comprises medium 100 rotated by a motor 202. A pair of read-write heads 204a, 204b are coupled via arms 206a, 206b to an actuator 208 which in turn positions heads 204a, 204b over selected tracks of medium 100. Heads 204a, 204b write data to and read data from medium 100. Although FIG. 16 shows only one medium in drive 200, drive 200 can comprise more than one medium and more than one pair of read-write heads.

While the invention has been described with respect to specific embodiments, those skilled in the art will recognize that modifications can be made in form and detail without departing from the spirit and scope of the invention. For example, seed layer 108 can be amorphous and consist essentially of Ta or an amorphous alloy of predominantly Ta, e.g. any additives in the alloy do not have a major impact on the properties of the alloy. In one embodiment, layer 108 is 90 to 100% Ta (although as used herein, a layer consisting of 100% Ta does not exclude those impurities typically found in layers formed by sputtering from commercially available Ta sputtering targets, e.g. targets of 99.9% purity or better).

Layer 110 can be NiWₓ, where x is between 6 and 15, and preferably between 6 and 12. The remainder of layer 10 can be or consist essentially of Ni. 12% is the solid solubility limit for W in Ni. At concentrations exceeding 15%, W causes the NiW crystallinity to deteriorate and finally become amorphous, whereas it is desirable to use FCC material for layer 110. In one embodiment, one provides a W concentration to increase the lattice spacing of the NiW to match the lattice spacing of the magnetic layers. In some embodiments, for a concentration below 6%, the effect of W on the lattice spacing of layer 110 may be insufficient. In one embodiment, layer 110 consists essentially of Ni and W, and in another embodiment, layer 110 consists of Ni and W (although as used herein, a layer consisting of materials, e.g. Ni and W, does not exclude impurities that are generally found in layers that are sputtered from commercially available sputtering targets, e.g. targets of about 99.9% purity or better).

Alternatively, layer 110 can be NiCuWₓ, where x is between 1 and 15 or NiCoWₓ, where x is between 6 and 15. In the case of an alloy comprising Ni, Cu and W, the Cu content can be from 0 to an amount equal to the Ni content. (This is because such a composition will not adversely affect the FCC crystal structure of layer 110.) For the case of an alloy comprising Ni, Co and W, the Co content can be from 0 to 30%. In other embodiments additives other than (or in addition to) Cu and/or Co may be present in the NiW alloy of layer 110. In some embodiments, Ni is the predominant component in the alloy. Again, such embodiments are FCC non-magnetic alloys.

Layer 112 can be Ru, a Ru-based alloy, or a Co-based alloy, e.g. comprising one or more of Cr, Ta, W, Mo, Nb, Ti, Hf, Y, V, Sr or Ni. A disk in accordance with the invention can include other layers (including other magnetic layers) in addition to the ones described herein. Also, layers having different thicknesses can be used. For example, in some embodiments, the total thickness of the magnetic recording layers can be 10 to 18 nm thick, e.g. between 14 and 16 nm thick. Accordingly, all such changes come within the present invention.

We claim:

1. A magnetic recording medium comprising:
a substrate;
a SUL formed over the substrate;
a seed layer comprising amorphous Ta formed over the SUL;
a non-magnetic FCC alloy comprising Ni and W formed over the seed layer;
a non-magnetic HCP underlayer formed over the non-magnetic alloy; and
a magnetic layer formed over the non-magnetic HCP underlayer.

2. Magnetic recording medium of claim 1 wherein the non-magnetic alloy is a FCC alloy comprising from 6 to 15 at. % W and the remainder substantially being Ni, the magnetic layer comprises first and second sublayers, said medium further comprising: an adhesion layer between the SUL and the substrate and a protective overcoat over the magnetic layer.

3. A magnetic disk drive comprising the medium of claim 1.

4. A method for making a magnetic recording medium comprising:
forming a SUL over a substrate;
forming a seed layer comprising amorphous Ta formed over the SUL;
forming a non-magnetic FCC alloy comprising Ni and W formed over the seed layer;
forming a non-magnetic HCP underlayer formed over the non-magnetic alloy; and
forming a magnetic layer formed over the non-magnetic HCP underlayer.

5. Method of claim 4 wherein the non-magnetic alloy is a FCC alloy comprising from 6 to 15 at. % W and the remainder substantially being Ni, the magnetic layer comprises first and second sublayers, said method further comprising:
forming an adhesion layer between the SUL and the substrate; and
forming a protective overcoat over the magnetic layer.
